(19) United States
(12) Patent Application Publication
(10) Pub. No.: US 2025/0267560 A1
(43) Pub. Date: Aug. 21, 2025

(54) NETWORK SLICE NOTIFICATIONS IN WIRELESS COMMUNICATION NETWORKS

(71) Applicant: T-MOBILE INNOVATIONS LLC, Overland Park, KS (US)

(72) Inventor: Baewon Seo, Overland Park, KS (US)

(21) Appl. No.: 18/582,992

(22) Filed: Feb. 21, 2024

(51) Int. Cl. H04W 48/16; H04W 48/18

(52) U.S. Cl. CPC H04W 48/16; H04W 48/18

(57) ABSTRACT

Various embodiments comprise a wireless communication network to notify wireless user devices of available network slices. The wireless communication network comprises a network analytics service and slice notification system. The network data analytics service receives data generated by a diagnostics application hosted by a wireless user device that characterizes user behavior. The network data analytics service correlates the user behavior to a wireless network slice that the user device is not authorized to use. The slice notification system generates slice notification that identifies the wireless network slice. The slice notification system delivers the slice notification to the wireless user device wherein the wireless user device receives and displays the slice notification.

### TECHNICAL FIELD

Various embodiments of the present technology relate to network slicing, and more specifically, to notifying users of available network slices.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources to provide a specific service. Network slices may be configured to provide low-latency services, media streaming services, Internet-of-Things (IoT) services, and the like. Exemplary slice types include Ultra-Reliable Low Latency Communication (URLLC), Enhanced Mobile Broadband (eMBB), and Massive Internet-of-Things (MIoT). By implementing network slicing, wireless communication networks optimize the computing and radio resources for specific service types thereby enhancing the overall user experience. To receive service on a given wireless network slice, the user device must typically be subscribed for service on that network slice. When a user device attempts to access a network slice that it is not subscriber to (e.g., paying for), the wireless communication network blocks the device from accessing that slice. However, user devices may still download or otherwise host user applications configured to use specific network slices that the devices are not subscribed to. For example, a device may host a user application that requires ultra-low latency but may not be authorized to access the network's URLLC slices. This misalignment degrades the overall user experience.

Unfortunately, wireless communication networks do not efficiently inform wireless user devices of the available network slices on the network. Moreover, wireless communication networks do not effectively create new network slices based on device behavior on the network.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method of operating a wireless communication network to notify wireless user devices of available network slices. The method comprises receiving data generated by a diagnostics application hosted by a wireless user device that characterizes user behavior. The method further comprises correlating the user behavior to a wireless network slice that the user device is not authorized to use. The method further comprises generating a slice notification that identifies the wireless network slice. The method further comprises delivering the slice notification to the wireless user device wherein the wireless user device receives and displays the slice notification.

Some embodiments comprise a wireless communication network to notify wireless user devices of available network slices. The wireless communication network comprises a network analytics service and a slice notification system. The network data analytics service receives data generated by a diagnostics application hosted by a wireless user device that characterizes user behavior. The network data analytics service correlates the user behavior to a wireless network slice that the user device is not authorized to use. The slice notification system generates a slice notification that identifies the wireless network slice. The slice notification system delivers the slice notification to the wireless user device wherein the wireless user device receives and displays the slice notification.

Some embodiments comprise one of more non-transitory computer readable storage media having program instructions stored thereon to notify wireless user devices of available network slices. When executed by a computing system, the program instructions direct the computing system to perform operations. The operations comprise receiving data generated by a diagnostics application hosted by a wireless user device that characterizes user behavior. The operations further comprise correlating the user behavior to a wireless network slice that the user device is not authorized to use. The operations further comprise generating a slice notification that identifies the wireless network slice. The operations further comprise delivering the slice notification to the wireless user device wherein the wireless user device receives and displays the slice notification.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network to notify wireless user devices of available network slices.

FIG. 2 illustrates an exemplary operation of the communication network to notify wireless user devices of available network slices.

FIG. 3 illustrates a wireless communication network to notify wireless user devices of available network slices.

FIG. 4 illustrates an exemplary operation of the wireless communication network to notify wireless user devices of available network slices.

FIG. 5 further network elements in the wireless communication network.

FIG. 6 illustrates a Fifth Generation (5G) communication network to notify wireless user devices of available network slices.

FIG. 7 illustrates a 5G User Equipment (UE) in the 5G communication network.

FIG. 8 illustrates a 5G Radio Access Network (RAN) in the 5G communication network.

FIG. 9 illustrates network functions in the 5G communication network.

FIG. 10 illustrates a Network Function Virtualization Infrastructure (NFVI) in the 5G communication network.

FIG. 11 further illustrates the NFVI in the 5G communication network.

FIG. 12 illustrates an exemplary operation of the 5G communication network to notify wireless user devices of available network slices.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

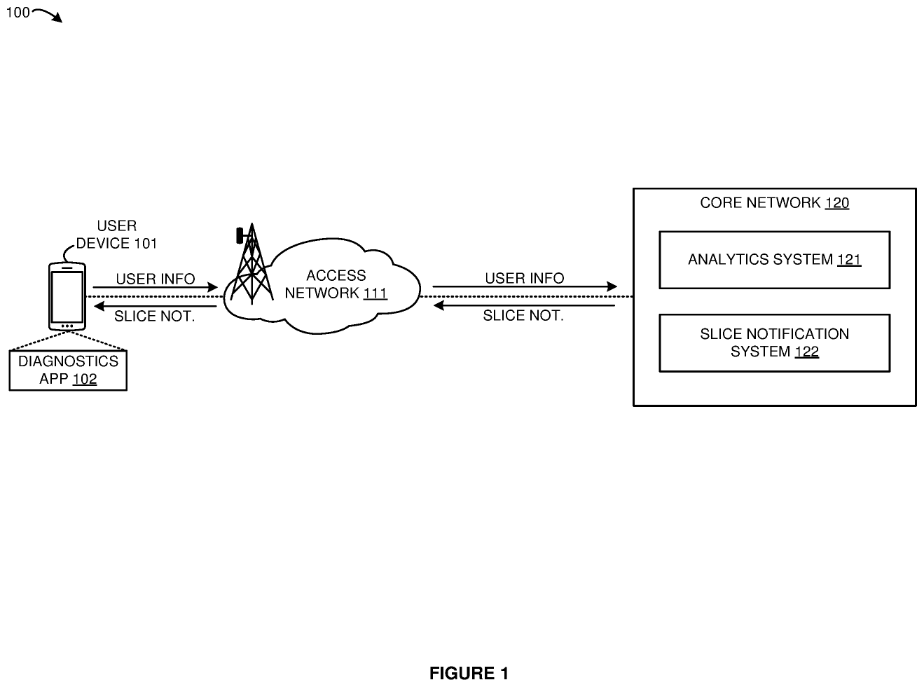

FIG. 1 illustrates communication network 100 to notify wireless user devices of available network slices. Communication network 100 delivers services like media-streaming, internet-access, voice/video calling, text messaging, machine communications, or some other wireless communications product. Communication network 100 comprises user device 101, access network 111, and core network 120. User device 101 comprises diagnostics application (APP) 102. Core network 120 comprises analytics system 121 and slice notification system 122. In other examples, communication network 100 may comprise additional or different elements than those illustrated in FIG. 1.

Various examples of network operation and configuration are described herein. In some examples, user device 101 provides user information (INFO) to core network 120 over access network 111. The user information is generated by diagnostics application 102 and characterizes the user's behavior while using device 101. For example, the user information may indicate the applications used by the user, the amount of uplink data transferred by device 101, the amount of downlink data received by device 101, and/or other information characterizing the operation of device 101.

Core network 120 receives the user information and provides the information to analytics system 121. Analytics system 121 processes the user information to correlate the user behavior to a network slice. Typically, analytics system 121 will correlate the user behavior to a network slice that the device 101 is not currently subscribed to. In response, analytics system 121 notifies slice notification system 122 of the correlated network slice. Slice notification system 122 generates a slice notification (SLICE NOT.) for device 101 that indicates the network slice and delivers the notification to device 101 over access network 111. User device 101 receives and displays the notification for the user. For example, the slice notification may comprise an advertisement, promotion, and/or other type of marketing communication that identifies the network slice.

Communication network 100 provides wireless data services to wireless user devices like user device 101. Exemplary wireless data services include internet-access, media-streaming, social-networking, and machine-control. Exemplary wireless user devices comprise phones, computers, vehicles, robots, and sensors. Access network 111 comprises an example of a Radio Access Network (RAN). RANs exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores like core network 120. The RANs are connected to the wireless network cores over backhaul data links. Access network 111 and core network 120 may communicate via edge networks like internet backbone providers, edge computing systems, or another type of edge system to provide the backhaul data links between node 111 and core network 120.

The RANs (e.g., access network 111) comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user device 101 over access network 111. Exemplary computing systems comprise Network Function Virtualization (NFVI) systems, data centers, server farms, cloud computing networks, hybrid cloud networks, and the like. The computing systems of core network 120 store and execute the network functions to form network analytics system 121 and slice notification system 122. Analytics system 121 and slice notification system 122 may comprise network functions like Access and Mobility Management Function (AMF), Session Management Function (SMF), User Plane Function (UPF), Network Slice Selection Function (NSSF), Unified Data Management (UDM), Network Slice Management Function (NSMF), Network Data Analytics Function (NWDAF), Network Exposure Function (NEF), Application Function (AF), and the like. Core network 120 may comprise a Fifth Generation Core (5GC) architecture or another type of core network architecture.

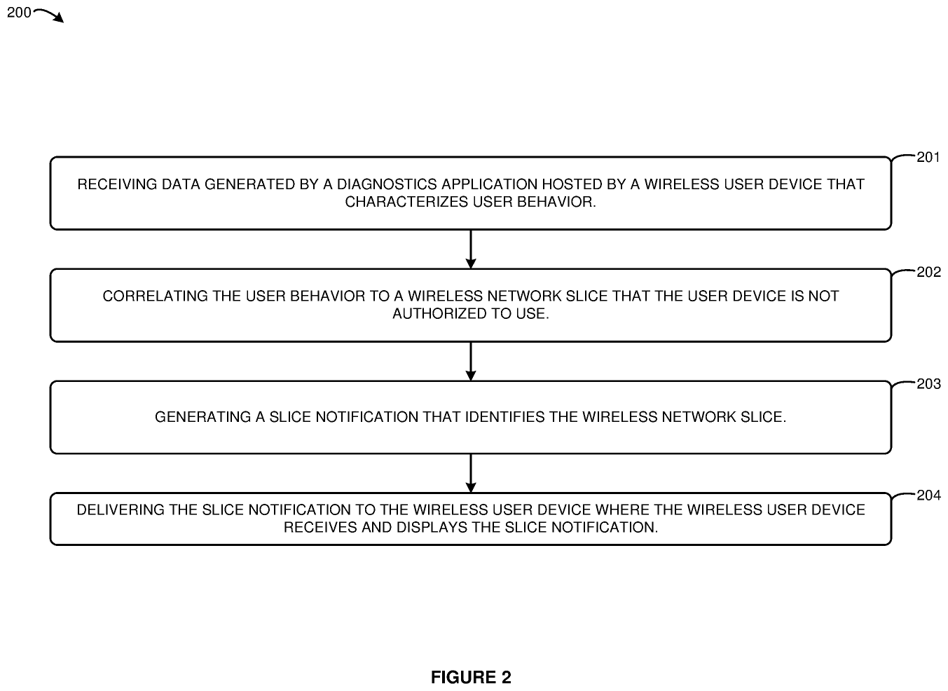

FIG. 2 illustrates process 200. Process 200 comprises an exemplary operation of communication network 100 to notify wireless user devices of available network slices. The operation may vary in other examples. The operations of process 200 comprise receiving data generated by a diagnostics application hosted by a wireless user device that characterizes user behavior (step 201). The operations further comprise correlating the user behavior to a wireless network slice that the user device is not authorized to use (step 202). The operations further comprise generating a slice notification that identifies the wireless network slice (step 203). The operations further comprise delivering the slice notification to the wireless user device where the wireless user device receives and displays the slice notification (step 204).

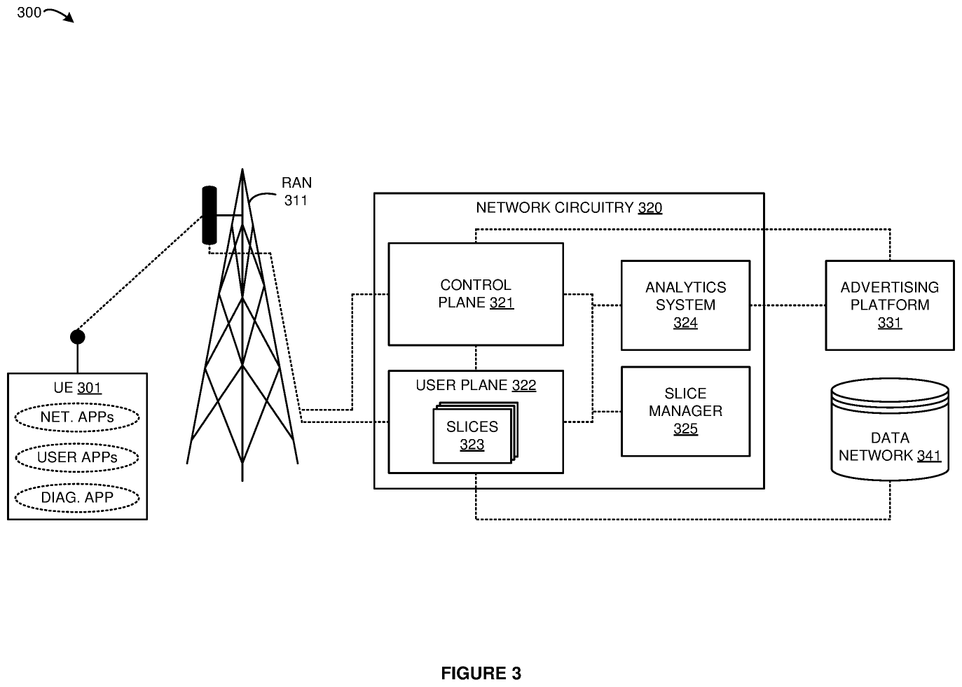

FIG. 3 illustrates wireless communication network 300 network to notify wireless user devices of available network slices. Wireless communication network 300 is an example of communication network 100, however network 100 may differ. Wireless communication network 300 comprises User Equipment (UE) 301, RAN 311, network circuitry 320, advertising platform 331, and data network 341. UE 301 hosts network applications (NET. APPs), user applications (USER APPs), and a diagnostics application (DIAG. APP). Network circuitry 320 comprises control plane 321, user plane 322, analytic system 324, and slice manager 325. User plane 322 comprises network slices 323. In other examples, wireless network communication network 300 may comprise additional or different elements than those illustrated in FIG. 3.

In some examples, UE 301 attaches to network circuitry 320 over RAN 311. Control plane selects one or more of slices 323 for UE 301 and directs user plane 322 to serve UE 301 the selected slices. UE 301 exchanges user data with user plane 322 over the selected network slices. User plane 322 exchanges the user data with data network 341. The diagnostic application monitors the operation of UE 301 as UE 301 receives wireless data services. The diagnostics application determines information like application usage, application type, uplink/downlink volume, and the like. The diagnostics application generates a usage report that includes the determined information and transfers the usage report to control plane 321 over RAN 311. Control plane 321 delivers the usage report to analytics system 324.

Analytics system 324 processes the usage report to correlate the user behavior to one of network slices 323 that UE 301 is not currently authorized to use. For example, the usage report may indicate UE 301 utilizes media broadcasting applications that have a high uplink data volume and analytics system 324 may correlate this behavior to one of slices 323 with capabilities for media broadcasting. Analytics system 324 exposes the correlated network slices to advertising platform 331. Platform 331 generates an advertisement that indicates the network slice for UE 301. For example, when UE 301 has been categorized as a media streaming device by analytics system 324, platform may generate an advertisement that identifies a media streaming network slice and includes a link for UE 301 to upgrade their subscription to include access for the media streaming slice. Advertising platform 331 transfers the advertisement to control plane 321 which controls user plane 322 to deliver the advertisement to UE 301.

In some examples, analytics system 324 may determine there does not currently exist a slicing option that correlates well with the user behavior identifies in the usage report generated by the diagnostics application hosted by UE 301. In such cases, analytics system 324 may interface with slice manager 325 to instantiate a new one (or modify an existing one) of slices 323 based on the user behavior. Slice manager 325 interfaces with Orchestration and Management (OAM) systems (not illustrated) to secure the computing resources to instantiate the new slice type. Once instantiated, analytics system 324 drives platform 331 to generate an advertisement for the new slice. Platform 331 generates the advertisement and delivers the advertisement to UE 301 as described above.

Advantageously, wireless communication network 300 efficiently informs wireless UEs of the available network slices on the network that the UEs are unaware of and/or unauthorized to use. Moreover, wireless communication network 300 effectively creates new network slices based on device behavior on the network.

UE 301 and RAN 311 communicate over links using wireless/wired technologies like 5GNR, LTE, LP-WAN, WIFI, Bluetooth, and/or some other type of wireless or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface. RAN 311, network circuitry 320, advertising platform 331, and data network 341 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 comprises a vehicle, drone, robot, computer, phone, sensor, or another type of data appliance with wireless and/or wireline communication circuitry. Although RAN 311 is illustrated as a tower, RAN 311 may comprise another type of mounting structure (e.g., a building), or no mounting structure at all. RAN 311 comprises a Fifth Generation (5G) RAN, LTE RAN, gNodeB, eNodeB, NB-IoT access node, trusted non-Third Generation Partnership Project (3GPP) access node, untrusted non-3GPP access node, LP-WAN base station, wireless relay, WIFI hotspot, Bluetooth access node, and/or another wireless or wireline network transceiver. UE 301 and RAN 311 comprise antennas, amplifiers, filters, modulation, analog/digital interfaces, microprocessors, software, memories, transceivers, bus circuitry, and the like. The control plane network functions comprise network functions like AMF, SMF, NSSF, NEF, AF, and the like. The user plane network functions comprise network functions like UPF and the like. Advertising platform 331 comprises an application server to generate ads the identify network slices available for purchase by UE 301. Data network 341 comprises an application server that hosts applications (e.g., media streaming applications) for UE 301.

UE 301, RAN 311, network circuitry 320, advertising platform 331, and data network 341 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 300 as described herein.

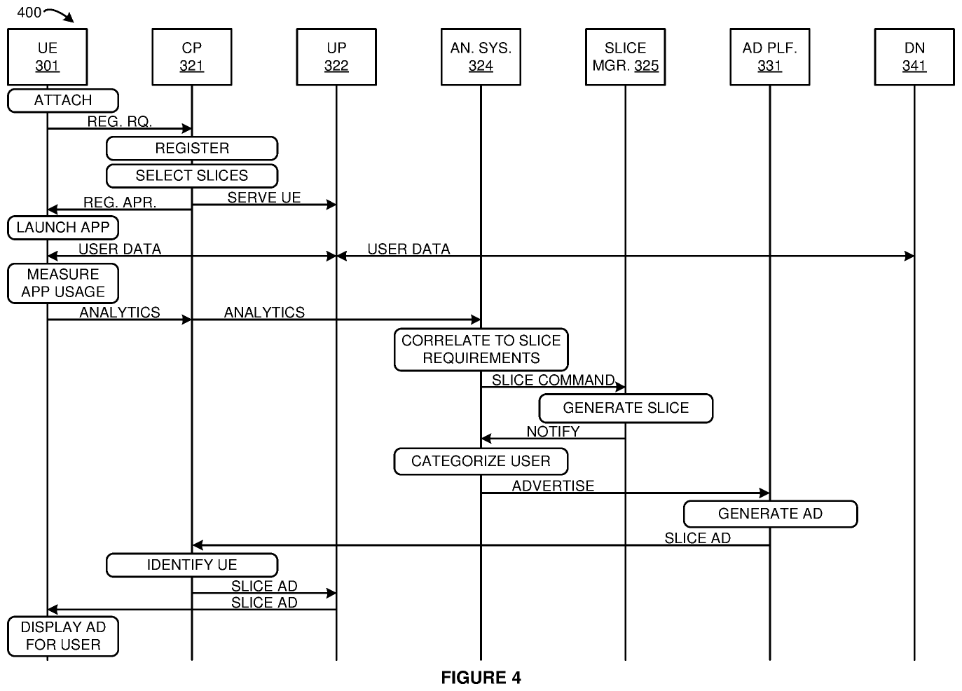

FIG. 4 illustrates process 400. Process 400 comprises an exemplary operation of wireless communication network 300 to notify wireless user devices of available network slices. The operation may vary in other examples. In some examples, UE 301 wirelessly attaches to RAN 311 and the network application hosted by UE 301 interface with RAN 311 to establish a signaling link. UE 301 transfers a registration request (REG. RQ.) to control plane (CP) 321 over RAN 311. Control plane 321 registers UE 301 for wireless data services and selects a set of network slices 323 for UE 301. For example, control plane 321 may access the subscriber profile for UE 301 that indicates ones of slice 323 that UE 301 is authorized to use and may select authorized ones of slice 323 to serve UE 301. Once the slices are selected, control plane 321 directs user plane (UP) 322 and transfers a registration approval (REG. APR.) message to UE 301 over RAN 301.

UE 301 receives the registration approval message and launches a user application. Exemplary user applications include media streaming applications, media broadcasting applications, social media applications, low-latency applications, voice/video conferencing applications, online gaming applications, extended/virtual reality applications, and the like. UE 301 exchanges user data with user plane 322. User plane 322 exchanges the user data with data network (DN) 341. As UE 301 participates in the session, the diagnostics application generates analytics that characterize the session of UE 301. The analytics may include metrics like uplink traffic volume, downlink traffic volume, application usage, application type, session length, session number, and the like. The diagnostics application transfers the analytics data to analytics system (AN. SYS.) 324 over RAN 324 and control plane 321.

Analytics system 324 correlates the received analytics data to slice requirements. For example, analytics system 324 may correlate data like uplink traffic volume, downlink traffic volume, application usage, application type, session length, and session number to slice service values like latency, uplink/downlink throughput, uplink/downlink data rate, Guaranteed Bit Rate (GBR) requirements, Quality-of-Service Class Indicator (QCI), and/or other service values that define the capabilities of a network slice. Analytics system 324 transfers a slice command to slice manager (SLICE MGR.) 325 to generate a new network slice that comprises the correlated service values. Slice manager 325 receives the command and generates the new network slice using the correlated service values. For example, slice manager 325 may interface with OAM to instantiate a set of control plane and user plane network functions that have capabilities to support the latency, uplink/downlink throughput, uplink/downlink data rate, GBR requirements, QCI, and/or other service values correlated by system 324. Slice manager 325 notifies analytics system 324 of the slice creation.

Analytics system 324 receives the notification and categorizes the user of UE 301 based on the analytics generated by the diagnostics application. Analytics system 324 correlates the user behavior depicted by the analytics to the newly created network slice. In response, analytics system 324 transfers an advertisement command to advertisement platform (AD PLF.) 331 to push ads to UE 301 that indicate the newly generated network slice. Platform 331 generates and transfers the advertisement to control plane 321. Control plane 321 identifies the UE for the advertisement and delivers the advertisement to UE 301 over user plane 322. UE 322 displays the advertisement for the user.

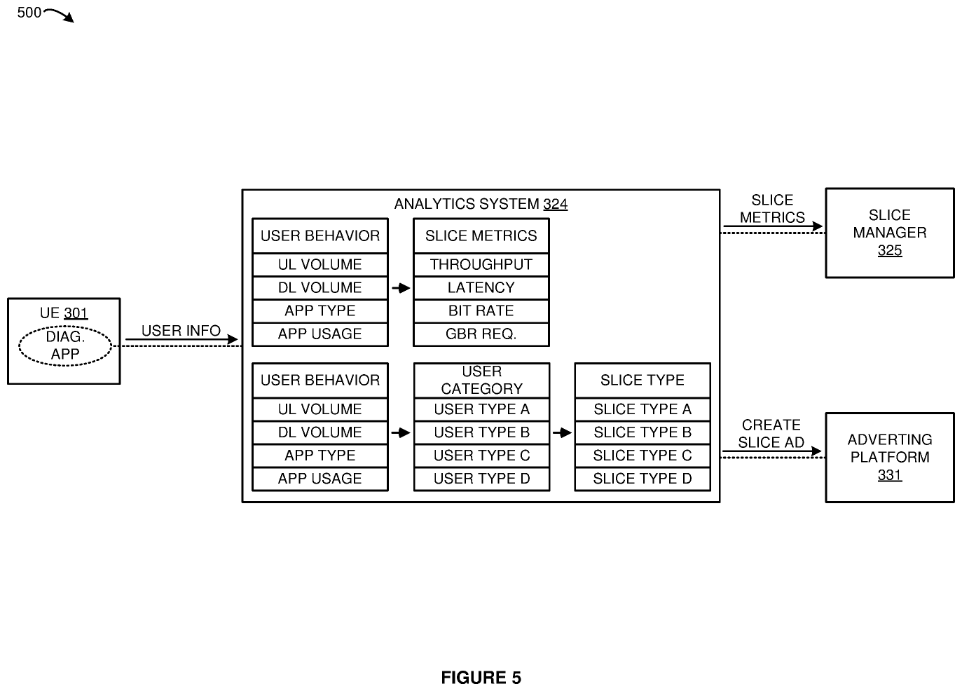

FIG. 5 illustrates further illustrates UE 301, analytics system 324, slice manager 325, and advertising platform 331. In some examples, analytics system 324 receives user information generated by the diagnostics application hosted by UE 301. Analytics system 324 hosts a data structure that implements the correlation tables illustrated in FIG. 5. The data structure correlates user behavior data to slice metrics to generate new network slices. As illustrated in FIG. 5, analytics system 324 correlates the user behavior inputs uplink (UL) volume, downlink (DL) volume, application type, and application usage to the slice metrics throughput, latency, bit rate, and GBR requirement (REQ.). For example, the input user behavior data may comprise an uplink data volume of 7 Gb, a downlink data volume of 3 Gb, a gaming application type and a media broadcasting application type, a 70% usage time for the gaming application, and a 30% usage time for the media broadcasting application. Analytics system 324 delivers the correlated slice metrics to slice manager 325 to instantiate new network slices.

As illustrated in FIG. 5, the data structure also categorizes the user into the user categories type A-D based on the behavior inputs of uplink volume, downlink volume, application type, and application usage. Exemplary user types include standard internet access user, media streamer, media broadcaster, gamer, live video/voice conference user, and the like. Analytics system 324 then selects a network slice of type A-D for promotion to UE 301 based on the user categorization. Exemplary slice types include Ultra-Reliable Low Latency Communications slices (URLLC), Enhanced Mobile Broadband (eMBB) slices, Massive Internet-of-Things (MIoT) slices, metaverse slices, media streaming slices, security slices, gaming slices, and the like. When the behavior of UE 301 is associated with a slice type that it is not currently authorized to use, analytics system 324 transfers a request to advertising platform 331 to create a slice advertisement for UE 301 that indicates the network slice type. Platform 331 may then forward the advertisement to control plane 321 and/or user plane 322 to deliver the advertisement to UE 301 via Non-Access Stratum (NAS) signaling, Short Message Service (SMS), downlink data packets, and the like.

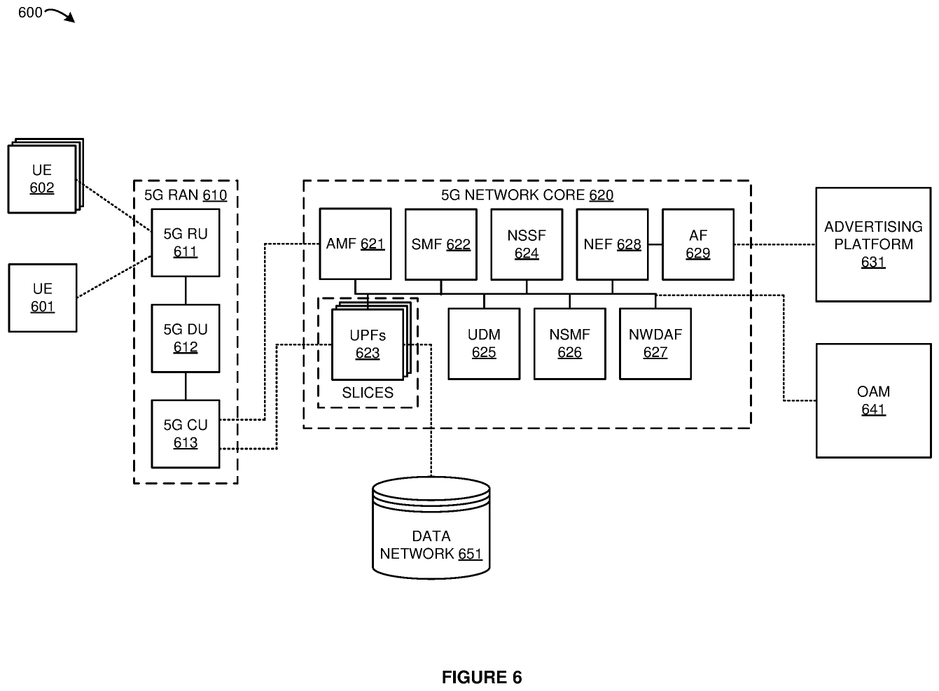

FIG. 6 illustrates 5G communication network 600 to notify wireless user devices of available network slices. 5G communication network 600 comprises an example of communication network 100 illustrated in FIG. 1 and wireless communication network 300 illustrated in FIG. 3, however networks 100 and 300 may differ. 5G Communication network 600 comprises 5G UEs 601 and 602, 5G RAN 610, 5G network core 620, advertising platform 631, Orchestration and Management 641 (OAM), and data network 651. 5G RAN 610 comprises Radio Unit (RU) 611, Distributed Unit (DU) 612, and Centralized Unit (CU) 613. 5G network core 620 comprises Access and Mobility Management Function (AMF) 621, Session Management Function (SMF) 622, User Plane Functions (UPFs) 623, Network Slice Selection Function (NSSF) 624, Unified Data Management (UDM) 625, Network Slice Management Function (NSMF) 626, Network Data Analytics Function (NWDAF) 627, Network Exposure Function (NEF) 628, and Application Function (AF) 629. UPF 623s form a variety of network slices. Other network functions and network entities like Authenticating Server Function (AUSF), Unified Data Registry (UDR), Network Repository Function (NRF), Policy Control Function (PCF), Service Communication Proxy (SCP), and Equipment Identity Registry (EIR), are typically present in 5G network core 620 but are omitted for clarity. In other examples, 5G communication network 600 may comprise different or additional elements than those illustrated in FIG. 6.

In some examples, UEs 602 wirelessly attach to RAN 610. UEs 602 transfer registration requests to AMF 621 over RAN 610. The registration requests include information like registration type, UE capabilities, Network Slice Selection Assistance Information (NSSAI) requests, Protocol Data Unit (PDU) session requests, and the like. In response to the registration request, AMF 621 transfers identity requests to UEs 602 over RAN 610. UEs 602 indicate their identities to AMF 621 over RAN 610. For example, UEs 602 may signal their Subscriber Concealed Identifiers (SUCIs) to AMF 621 over RAN 610. AMF 621 interacts with other network functions to authenticate the identities of UEs 602 and authorize UEs 602 for wireless data service. For example, AMF 621 may transfer an authentication request to an AUSF that includes the SUCI for one of UEs 602. The AUSF may then interface with UDM 625 to retrieve authentication data to verify the SUCI of the UE. The authentication data typically comprises the Subscriber Permanent Identifier (SUPI) for the UE and authentication vectors like an authentication challenge, key selection criteria, and a random number. The AUSF then transfers the authentication data and SUPI to AMF 621. AMF 621 may transfer an authentication challenge, key selection criteria, and random number to the one of UEs 602 over RAN 610. The UE may hash the random number using its copy of the secret key to generate an authentication response and transfer the response to AMF 621 over RAN 610. AMF 621 may authenticate the UE by matching the authentication response generated by the UE with the expected result.

Responsive to the authentication, AMF 621 registers UEs 602 for service on network 600. AMF 621 accesses subscriber profiles for UEs 602 to generate UE context to serve UEs 602. For example, AMF 621 may select UDM 625 to retrieve subscriber information for one of UEs 602. AMF 621 may transfer a context get request to UDM 625 to retrieve data like QoS metrics, allowed NSSAI, service attributes, service authorizations, and the like from UDM 625. UDM 625 returns the requested information to AMF 621 which generates UE context comprising the information retrieved from UDM 625. AMF 621 may additionally select and register with a PCF to create network policy associations for UEs 602.

As illustrated in FIG. 6, the network slices comprise UPFs 623. The slices may comprise URLLC slices, eMBB slices, MIoT slices, metaverse slices, media streaming slices, security slices, gaming slices, and the like. Although the slices are illustrated as comprising only UPFs 623, in other examples the slices may comprise additional network functions or RAN elements in network 600. For example, network core 620 may comprise multiple AMFs and SMFs and the slices may each comprise an AMF and an SMF in addition to UPFs 623. When the slices comprise multiple network functions, some of the network functions may be shared between the network slices. For example, two slices may each comprise SMF 622 while a third slice may comprise another SMF. It should be appreciated that the slices illustrated in FIG. 6 are exemplary and the slice configuration implemented by network core 620 may differ in other examples.

Once the context is generated, AMF 621 selects NSSF 624 to select network slices for UEs 602. AMF 621 transfers a get request to NSSF 624 to map the NSSAI requested by UEs 602 to available network slices in network core 620. NSSF 624 receives the request and maps the NSSAI included in the get request to one or more of the network slices. NSSF 624 returns the slice mappings to AMF 621 which then selects network slices requested by UEs 602. For example, the slices may comprise an URLLC slice, an eMBB slice, an MIoT slice a GBR network slice, and the like. UEs 602 may include S-NSSAI for the URLLC slice, the eMBB slice, the MIoT slice, and the GBR slice in the initial registration requests. NSSF 624 may map the S-NSSAIs in the get request to these slices to identify network slices for UEs 602.

AMF 621 selects SMF 622 to serve UEs 602 based on the selected network slice, QOS metrics, requested PDU sessions, service attributes, and the like. AMF 621 directs SMF 622 to establish PDU sessions for UEs 602 and indicates the S-NSSAIs for the selected network slices to SMF 622. SMF 622 selects corresponding ones of UPFs 623 to serve UEs 602. SMF 622 indicates the network addresses for the selected ones of UPFs 623 to AMF 621. AMF 621 includes the network addresses in the UE contexts and transfers the contexts to UEs 602 over RAN 610. UEs 602 launch user applications and use their received UE context to establish PDU sessions over their network slices. The application may comprise a media streaming application, social media application, low-latency application, voice/video conferencing application, online gaming application, extended/virtual reality application, and the like. The user applications in UEs 602 generate uplink data and wireless transfer the uplink data to corresponding ones of UPFs 623 over RAN 610. The corresponding ones of UPFs 623 transfer the uplink user data to data network 651. Data network 651 generates downlink data for the PDU sessions and transfers the downlink data to corresponding ones of UPFs 623. The corresponding ones of UPFs 623 transfer the downlink user data to UEs 602 over RAN 610.

UEs 602 host diagnostics applications that generate data characterizing user behavior while UEs 602 are attached to the network. As UEs 602 participate in their PDU sessions, their diagnostics applications track the application types used by UEs 602, the usage amounts for the applications, the total throughput, uplink-to-downlink data ratio, and the data latency. The diagnostics applications generate usage reports that include the measured data. UEs 602 generate and transfer NAS signaling that carries the usage reports to AMF 621 over RAN 610. AMF 621 is subscribed to NWDAF 627 for user analytics reporting. AMF 621 receives the usage reports and forwards the reports to NWDAF 627 based on the subscription.

NWDAF 627 hosts a data structure to correlate the user behavior metrics generated by the diagnostics applications of UEs 602 to slice service values like Quality-of-Service (QOS), latency, data rate, data throughput, location/geographic availability, credential requirements, charging information, and/or other metrics that define the service provided by a network slice. For each of UEs 602, NWDAF 627 inputs the user behavior metrics into the data structure to determine slice service values tailored to the user behavior for each of UEs 602. NWDAF 627 transfers the tailored slice service values to NSMF 626 to adjust the service values of existing network slices or to form new slice options.

NSMF 626 manages the available network slices in core 620 and instantiates new network slices when required. NSMF 626 compares the service values derived by NWDAF 627 to the service values in the currently available network slices. If the existing network slices comprise the same or similar service values than those derived by NWDAF 627, NSMF 626 forgoes new slice creation (e.g., to inhibit redundancy) or slice adjustment. When NSMF 626 determines the existing network slices do not meet the service value requirements (e.g., by using a similarity threshold), NSMF 626 adjusts the service values of existing network slices to align with the service values derived by NWDAF 627. For example, NSMF 627 may decrease the latency of the currently available URLLC slices based on the service values derived by NWDAF 627 to create the new slicing option.

When new slice instantiation is required, (e.g., existing slice capacity is insufficient), NSMF 626 transfers a request to OAM 641 to reserve computing resources for the new network slices. The request includes the service values for the new slice. OAM 641 receives the request and reserves the hardware resources in network core 620 to create additional UPF(s) (and potentially other network functions) for the new network slices. OAM 641 transfers an instantiation command to network core 620 to instantiate the UPFs. Network core 620 forms the UPFs using the hardware resources allocated by OAM 641. OAM 641 transfers a slice creation command to NSMF 626 to create the network slice. NSMF 626 generates the new network slices using the one(s) of UPFs 623 spun up by OAM 641. NSMF 626 assigns S-NSSAIs (e.g., slice identifiers) for the new slices. NSMF 626 notifies NWDAF 627 of the new slicing options. For each of the slicing options, NWDAF 627 determines user types based on the service values that correspond to the slice types. For example, NWDAF 627 may define a user type as high-uplink data user and correlate this user type to a network slice with high-uplink data throughput capabilities.

Subsequently, UE 601 wirelessly attaches to RAN 610. UE 601 transfers a registration request to AMF 621 over RAN 610. AMF 621 interacts with the other network functions in core 620 to authenticate and authorize UE 601 for wireless data services as described above for UEs 602. Responsive to the authentication, AMF 621 registers UE 601 for service on network 600 and generates UE context for UE 601 using subscriber information retrieved from UDM 625. AMF 621 may additionally select and register with a PCF to create network policy associations for UE 601. Once the context is generated, AMF 621 interfaces with NSSF 624 to select network slices for UE 601. AMF 621 selects SMF 622 to serve UE 601 and directs SMF 622 to establish the PDU sessions for UE 601. SMF 622 selects ones of UPFs 623 to serve UE 601 based on the selected slices. SMF 622 indicates the network addresses for the selected ones of UPFs 623 to AMF 621. AMF 621 includes the network addresses in the UE context and transfers the context to UE 601 over RAN 610. UE 601 launches a user application and uses the UE context to establish PDU sessions over the selected network slices. The user application in UE 601 generates uplink data and wireless transfer the uplink data to corresponding ones of UPFs 623 over RAN 610. The corresponding ones of UPFs 623 transfer the uplink user data to data network 651. Data network 651 generates downlink data for the PDU sessions and transfers the downlink data to the corresponding ones of UPFs 623. The corresponding ones of UPFs 623 transfer the downlink user data to UE 610 over RAN 610.

UE 601 also hosts a diagnostic application that generates data characterizing user behavior while UE 601 is attached to the network. As UE 601 participates in its PDU sessions, the diagnostics application tracks the application types used by UE 601, the usage amounts for the applications, the total throughput, uplink-to-downlink data ratio, and the data latency. The diagnostics application generates a usage report that includes the measured data. UE 601 generates and transfers NAS signaling that carries the usage report to AMF 621 over RAN 610. AMF 621 forwards the usage report to NWDAF 627.

NWDAF 627 hosts a data structure that categorizes UE 601 based on the user behavior metrics generated by the diagnostics application of UE 601 and correlates the user type to a slice type. NWDAF 627 inputs the user behavior metrics into the data structure to determine a user type (e.g., high uplink throughput user) for UE 601. NWDAF 627 inputs the resulting user type into the data structure to determine a slice type for UE 601. Once the slice type is determined, NWDAF 627 queries UDM 625 to determine if UE 601 is currently subscribed to (e.g., authorized to receive service) the slice type. When UE 601 is subscribed to the resulting slice type, NWDAF 627 may forego slice advertising. When UE 601 is not subscribed for service on the correlated slice type, NWDAF 627 generates an advertisement request that identifies UE 601 and the slice type. NWDAF 627 transfers the advertisement request to NEF 628 which exposes the request to advertisement platform 631 over AF 629.

Advertisement platform 631 generates an advertisement for UE 601 that indicates the correlated network slice for UE 601. The advertisement may comprise a pop-up ad, SMS/text message ad, email ad, or another type of advertisement. The advertisement may include graphics and/or textual information to identify the network slice as well as monetary information to subscribe to the slice. The advertisement may additionally include selectable link that may direct UE 601 to a webpage to purchase a subscription for the network slice. Once the advertisement is generated, platform 631 transfers the advertisement to NEF 628 over AF 629. NEF 628 exposes the advertisement for UE 601 to AMF 621. AMF 621 may deliver the advertisement to UE 601 in either control plane or user plane signaling. For example, if the advertisement comprises an SMS advertisement, AMF 621 may transfer NAS signaling the carries the SMS advertisement to UE 601 over RAN 610. For example, if the advertisement comprises a pop-up advertisement, AMF 621 may forward the advertisement to UPFs 623 which then include the advertisement in the downlink data stream to UE 601. UE 601 receives the advertisement from network core 620 and responsively displays the advertisement for review by the user.

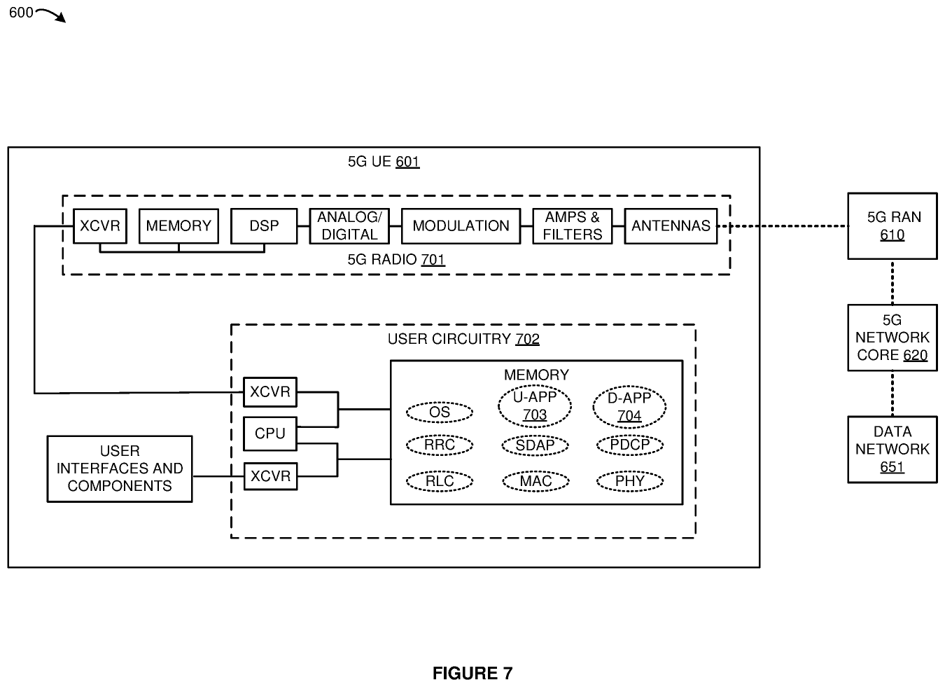

FIG. 7 illustrates 5G UE 601 in 5G communication network 600. UE 601 comprises an example of user device 101 and UE 301, although user device 101 and UE 301 may differ. UEs 602 comprise a similar architecture to UE 601. UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user application (U-APP) 703, diagnostics application (D-APP) 704, and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 610 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 610 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 610 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). User application 703 comprises a user application like a media streaming application, social media application, low-latency application, voice/video conferencing application, online gaming application, extended/virtual reality application, and the like. Diagnostics application 704 functions comprise application usage monitoring, uplink/downlink data throughput monitoring, and user behavior data reporting.

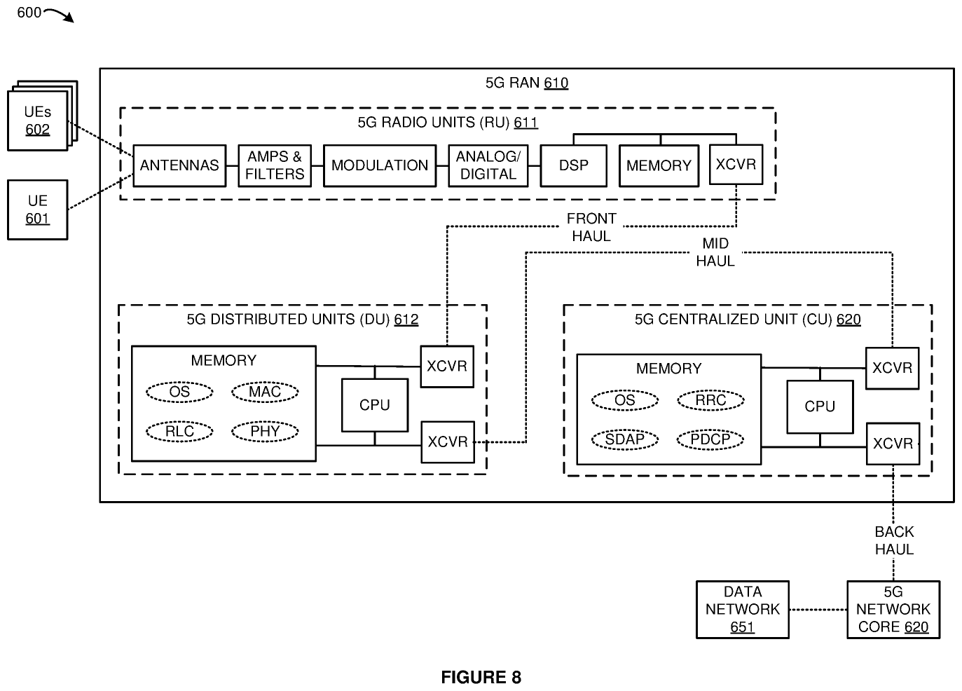

FIG. 8 illustrates 5G RU 611, 5G DU 612, and 5G CU 613 in 5G communication network 600. RU 611, DU 612, and CU 613 comprise an example of the access network 111 and RAN 311, although access network 111 and RAN 311 may differ. RU 611 comprises antennas, amplifiers, filters, modulation, analog-to-digital interfaces, DSP, memory, and transceivers (XCVRs) that are coupled over bus circuitry. UE 601 is wirelessly coupled to the antennas in RU 611 over 5GNR links. Transceivers in 5G RU 611 are coupled to transceivers in 5G DU 612 over fronthaul links like enhanced Common Public Radio Interface (eCPRI). The DSPs in RU 611 executes their operating systems and radio applications to exchange 5GNR signals with UE 601 and to exchange 5GNR data with DU 612.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 612 over the transceivers.

For the downlink, the DSPs receive downlink 5GNR symbols from DU 612. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 612 comprises memory, CPU, and transceivers that are coupled over bus circuitry. The memory in 5G DU 612 stores operating systems and 5GNR network applications like PHY, MAC, and RLC. CU 613 comprises memory, CPU, and transceivers that are coupled over bus circuitry. The memory in CU 613 stores an operating system and 5GNR network applications like PDCP, SDAP, and RRC. Transceivers in 5G DU 612 are coupled to transceivers in RU 611 over front-haul links. Transceivers in DU 612 are coupled to transceivers in CU 613 over mid-haul links. A transceiver in CU 613 is coupled to network core 620 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

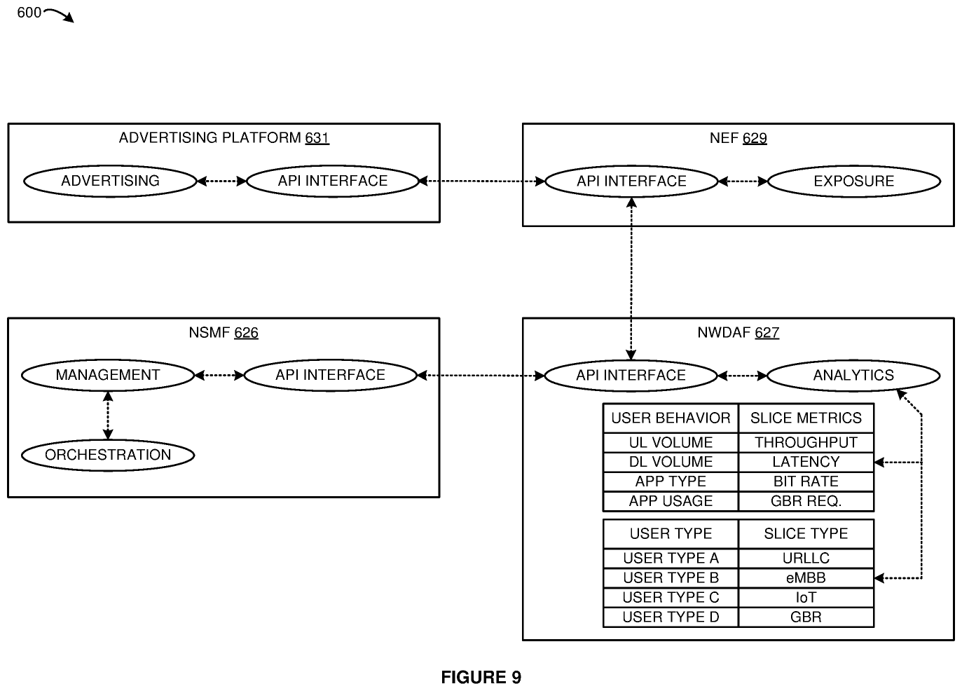

FIG. 9 illustrates NSMF 626, NWDAF 627, NEF 629, and advertising platform 631 in 5G communication network 600. In some examples, NSMF 627 comprises modules for slice management, slice orchestration, and Application Programming Interface (API) interfacing. The slice management model manages the resources allocated to the network slices in core 620. The slice orchestration module handles network slice instantiation and governs the RAN resources and network functions allocated to an instantiated slice. NWDAF 627 comprises modules for API interfacing, network analytics, and stores a data structure that correlates user behavior to slice metrics and correlates user types to slice types. The analytics module processes metrics received from subscribing network functions, RANs, and UEs in network 600 to generate network analytics data. The data structure correlates the user behavior metrics of uplink data volume, downlink data volume, application type, and application usage to the slice metrics of uplink/downlink throughput, latency, bit rate, and GBR requirement. The data structure correlates the user types A-D to the slice types of URLLC, eMBB, IoT, and GBR. Based on the outputs from the data structure, the analytics module may transfer requests to NSMF 626 to create new slices using the correlated metrics and to advertise network slices (including new slice created by NSMF 626) to UE based on the user type.

NEF 629 comprises modules for event exposure and API interfacing. The event exposure module exposes network events and third-party requests to the other functions resident in core 620. For example, the exposure module may expose slice advertisement requests generated by NWDAF 627 and/or NSMF 626 to advertising platform 631. Advertising platform 631 comprises modules for API interfacing and advertising. The advertising module generates ads for UE that indicate available network slices that the UE are not currently subscribed to. The ads may comprise pop-up ads for display on the UE, text message/SMS message ads, and/or other advertisement types. The ads may comprise links to mobile pages that allow the UE to upgrade or otherwise purchase a subscription for the advertised network slice. The interfacing modules allow NSMF 626, NWDAF 627, NEF 629, and platform 631 to communicate with each other and other elements in network 600.

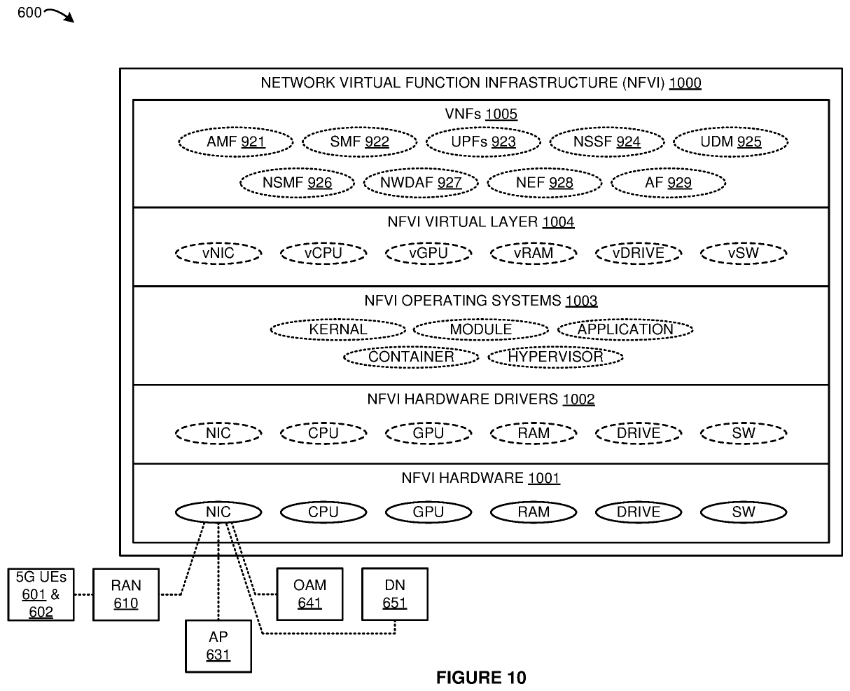

FIG. 10 illustrates Network Function Virtualization Infrastructure (NFVI) 1000 in 5G wireless communication network 600. NFVI 1000 comprises an example of core network 120 illustrated in FIG. 1 and network circuitry 320 illustrated in FIG. 3, although core network 120 and network circuitry 320 may differ. NFVI 1000 comprises NFVI hardware 1001, NFVI hardware drivers 1002, NFVI operating systems 1003, NFVI virtual layer 1004, and NFVI Virtual Network Functions (VNFs) 1005. NFVI hardware 1001 comprises Network Interface Cards (NICs), CPU, GPU, RAM, Flash/Disk Drives (DRIVE), and Data Switches (SW). NFVI hardware drivers 1002 comprise software that is resident in the NIC, CPU, GPU, RAM, DRIVE, and SW. NFVI operating systems 1003 comprise kernels, modules, applications, containers, hypervisors, and the like. NFVI virtual layer 1004 comprises vNIC, vCPU, vGPU, vRAM, vDRIVE, and vSW. NFVI VNFs 1005 comprise AMF 1021, SMF 1022, UPFs 1023, NSSF 1024, UDM 1025, NSMF 1026, NWDAF 1027, NEF 1028, and AF 1029. Additional VNFs and network elements like AUSF, UDR, NRF, PCF, SCP, and EIR are typically present but are omitted for clarity. NFVI 1000 may be located at a single site or be distributed across multiple geographic locations. The NIC in NFVI hardware 1001 is coupled to RAN 610, to advertising platform 631, to OAM 641, and to data network 651. NFVI hardware 1001 executes NFVI hardware drivers 1002, NFVI operating systems 1003, NFVI virtual layer 1004, and NFVI VNFs 1005 to form AMF 611, SMF 622, UPFs 623, NSSF 624, NSMF 626, CF 626, NEF 628, and AF 629.

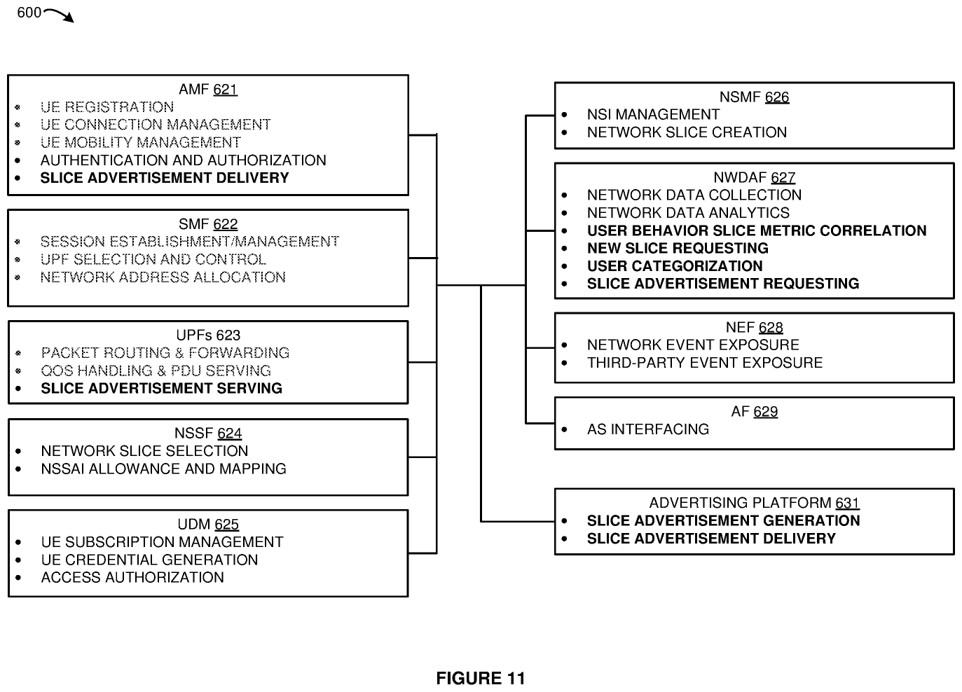

FIG. 11 further illustrates NFVI 1000 and advertising platform 631 in 5G communication network 600. AMF 621 comprises capabilities for UE registration, UE connection management, UE mobility management, authentication, authorization, and slice advertisement delivery. SMF 622 comprises capabilities for session establishment, session management, UPF selection, UPF control, and network address allocation. UPFs 623 comprise capabilities for packet routing, packet forwarding, QoS handling, PDU serving, and slice advertisement serving. NSSF 624 comprises capabilities for network slice selection, NSSAI allowance, and NSSAI mapping. UDM 625 comprises capabilities for UE subscription management, UE credential generation, and UE access authorization. NSMF 626 comprises capabilities for Network Slice Instance (NSI) management and network slice creation. NWDAF 627 comprises capabilities for network data collection, network data analytics, user behavior slice metric correlation, new slice requesting, user categorization, and slice advertisement requesting. NEF 628 comprises capabilities for network event exposure and third-party event exposure. AF 629 comprises capabilities for AS interfacing. Advertising platform 631 comprises capabilities for slice advertisement generation and slice advertisement delivery.

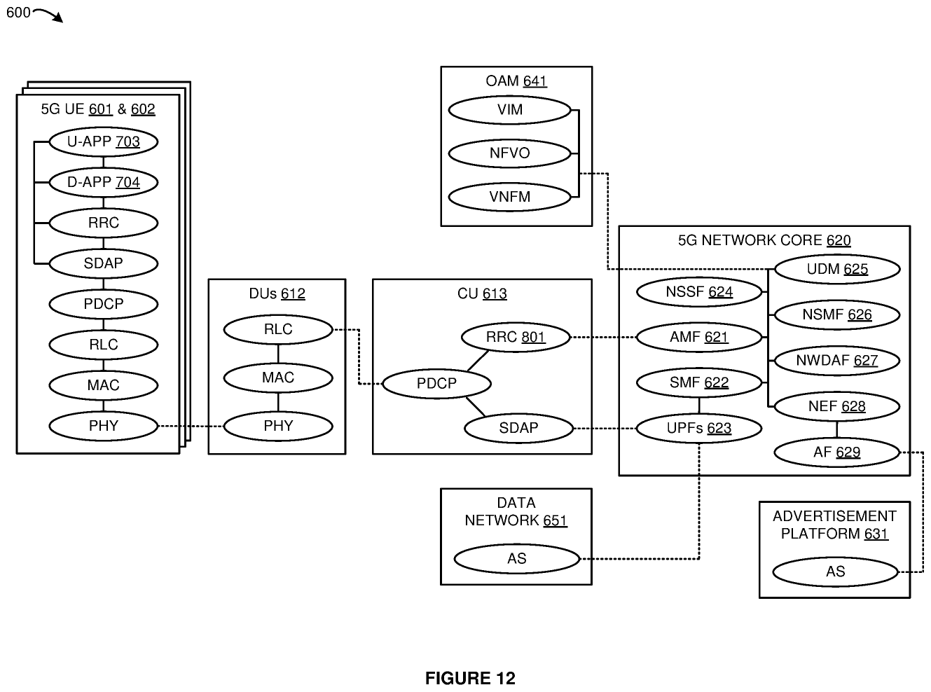

FIG. 12 illustrates an exemplary operation of 5G communication network 600 to notify wireless user devices of available network slices. In this example, OAM 641 comprises a Virtual Infrastructure Manager (VIM), a Network Function Virtualization Orchestrator (NFVO), and a Virtual Network Function Manager (VNFM). The VNFM comprises capabilities for network function interfacing, orchestration interfacing, network function instantiation, and network function deactivation. The NFVO comprises capabilities for network service management and network function request validation. The VIM comprises capabilities for network infrastructure management. The operation of network 600 may vary in other examples. In some examples, UEs 602 wirelessly attach to RAN 610. The RRCs in UEs 602 transfer registration requests to the RRC in CU 613 over the PDCPs, RLCs, MACs, and PHYs. AMF 621 responds to the request by transferring identity requests to the RRC in CU 613. The RRC in CU 613 forwards the identity requests to the RRCs in UEs 602 over the PDCPs, RLCs, MACs, and PHYs. The RRCs return their respective SUCIs to the RRC in CU 613 over the PDCPs, RLCs, MACs, and PHYs which forwards the SUCIs to AMF 621. AMF 621 interacts with other network functions (e.g., AUSF and UDM 625) to authenticate the identities of UEs 602 and authorize UEs 602 for wireless data service. Responsive to the authentication, AMF 621 registers UEs 602. AMF 621 accesses subscriber profiles managed by UDM 625 for UEs 602 to generate UE context to serve UEs 602. Once the context is generated, AMF 621 selects NSSF 624 to select network slices for UEs 602. AMF 621 transfers a get request to NSSF 624 to map the NSSAI requested by UEs 602 to available network slices in network core 620. NSSF 624 maps the NSSAI to the network slices. NSSF 624 returns the slice mappings to AMF 621 which then selects the network slices for UEs 602.

AMF 621 selects SMF 622 to serve UEs 602 and directs SMF 622 to establish PDU sessions for UEs 602. AMF 621 indicates the S-NSSAIs for the selected network slices to SMF 622. SMF 622 selects ones of UPFs 623 to serve UEs 602 based on the S-NSSAIs. SMF 622 indicates the network addresses for the selected ones of UPFs 623 to AMF 621. AMF 621 includes the network addresses in the UE contexts and transfers the contexts to the RRC in CU 613. The RRC forwards the contexts to the RRCs in UEs 602 over the PDCPs, RLCs, MACs, and PHYs. In response to user inputs, UEs 602 launch user applications 703. The RRCs use the received UE contexts to establish PDU sessions. The RRCs direct their corresponding SDAPs to begin the PDU sessions for applications 703 over their network slices. User applications 703 generate uplink data and the SDAPs transfer the uplink data to the SDAP in CU 613 over the PDCPs, RLCs, MACs, and PHYs which transfers the uplink data to corresponding ones of UPFs 623. The corresponding ones of UPFs 623 transfer the uplink user data to data network 651.

Data network 651 generates downlink data for the PDU sessions and transfers the downlink data to corresponding ones of UPFs 623. The corresponding ones of UPFs 623 transfer the downlink user data to the SDAP in CU 613. The SDAP transfers the downlink data to the SDAPs in UEs 602 over the PDCPs, RLCs, MACs, and PHYs.

UEs 602 launch diagnostics applications 704. Diagnostics applications 704 generate data characterizing user behavior while UEs 602 are attached to the network. As UEs 602 participate in their PDU sessions, diagnostics applications 704 track the application types used by UEs 602, the usage amounts for the applications, the total throughput, uplink-to-downlink data ratio, and the data latency. The diagnostics applications generate usage reports that include the measured data and transfer the reports to the RRCs. The RRCs transfers the usage reports to the RRC in CU 613 over the PDCPs, RLCs, MACs, and PHYs. The RRC forwards the usage reports to AMF 621. AMF 621 forwards the reports to NWDAF 627 based on the subscription.

For each of UEs 602, NWDAF 627 inputs the user behavior metrics into the data structure to determine slice service values tailored to the user behavior for each of UEs 602. NWDAF 627 transfers the tailored slice service values to NSMF 626 to adjust the service values of existing network slices or to form new slice options. When NSMF 626 determines the existing network slices do not meet the service value requirements (e.g., by using a similarity threshold), NSMF 626 transfers a request to the VNFM in OAM 641 to reserve computing resources for new network slices. The request includes the service values for the new slice. The NFVO in OAM 641 receives the request and interfaces with the VIM in OAM 641 to reserve the hardware resources in network core 620 to create additional UPF(s) (and potentially other network functions) for the new network slices. The VIM reserves the hardware resources and notifies the NFVO. In response, the NFVO directs the VNFM to instantiate the UPFs using the hardware resource reserved by the VIM. The VNFM transfers an instantiation command to network core 620 to instantiate the UPFs. Network core 620 forms the UPFs using the hardware resources allocated by the VIM. The NFVO generates and transfers to a slice creation command NSMF 626 that specifies the network address for the UPFs and directs NSMF 626 to create the network slice. NSMF 626 generates the new network slices using the ones of UPFs 623 spun up by OAM 641. NSMF 626 assigns S-NSSAIs for the new slices and notifies NWDAF 627 of the new slicing options. For each of the slicing options, NWDAF 627 determines user types based on the service values that correspond to the slice types.

Subsequently, UE 601 wirelessly attaches to RAN 610. The RRC in UE 601 transfers a registration request to the RRC in CU 613 over the PDCPs, RLCs, MACs, and PHYs. The RRC transfers the request to AMF 621. AMF 621 interacts with the other network functions in core 620 to authenticate and authorize UE 601 for wireless data services. Responsive to the authentication, AMF 621 registers UEs 601 for service on network 600 and generates UE context for UE 601 using subscriber information retrieved from UDM 625. Once the context is generated, AMF 621 interfaces with NSSF 624 to select network slices for UE 601. AMF 621 selects SMF 622 to serve UE 601 and directs SMF 622 to establish the PDU sessions for UE 601. SMF 622 selects ones of UPFs 623 to serve UE 601 and indicates the network addresses for the selected ones of UPFs 623 to AMF 621. AMF 621 includes the network addresses in the UE context and transfers the context to the RRC in CU 613. The RRC transfers the context to the RRC in UE 601 over the PDCPs, RLCs, MACs, and PHYs. UE 601 launches user application 703. The RRC in UE 601 directs the SDAP to begin the PDU session based on the UE context. User application 703 generates uplink data for the PDU session. The SDAP transfers the uplink data to the SDAP in CU 613 over the PDCPs, RLCs, MACs, and PHYs. The SDAP in CU 613 transfers the uplink data to corresponding ones of UPFs 623 over RAN 610. The corresponding ones of UPFs 623 transfer the uplink user data to data network 651. Data network 651 generates downlink data for the PDU sessions and transfers the downlink data to corresponding ones of UPFs 623. The corresponding ones of UPFs 623 transfer the downlink user data to the SDAP in CU 613 which transfers the downlink data to the SDAP in UE 601 over the PDCPs, RLCs, MACs, and PHYS.

UE 601 launches diagnostic application 704 to generate data characterizing user behavior while UE 601 is attached to the network. Diagnostics application 704 tracks the application types used by UE 601, the usage amounts for the applications, the total throughput, uplink-to-downlink data ratio, and the data latency. Diagnostics application 704 generates a usage report that includes the measured data and provides the report to the RRC in UE 601. The RRC transfers the report to the RRC in CU 613 over the PDCPs, RLCs, MACs, and PHYs. The RRC forwards the usage report to AMF 621 which in turn forwards the usage report to NWDAF 627. NWDAF 627 categorizes UE 601 based on the user behavior metrics generated by diagnostics application 704 and correlates the user type to a slice type. Once the slice type is determined, NWDAF 627 queries UDM 625 to determine if UE 601 is currently subscribed to the slice type. UDM 625 accesses the subscriber profile for UE 601 and notifies NWDAF 627 that UE 601 is not subscribed for service on the correlated slice type. In response, NWDAF 627 generates an advertisement request that identifies UE 601 and the slice type and transfers the request to NEF 628. NEF 628 exposes the request to advertisement platform 631 over AF 629.

Advertisement platform 631 generates an advertisement for UE 601 that indicates the correlated network slice for UE 601. Once the advertisement is generated, platform 631 transfers the advertisement to NEF 628 over AF 629. NEF 628 exposes the advertisement for UE 601 to AMF 621. AMF 621 generates an SMS message that includes the add and transfers the message to the RRC in CU 613. The RRC forwards the SMS message to the RRC in UE 601 over the PDCPs, RLCs, MACs, and PHYs. The RRC in UE 601 receives the SMS message and responsively displays the advertisement for network slice.

The wireless data network circuitry described above comprises computer hardware and software that form special-purpose network circuitry to notify wireless user devices of available network slices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to notify wireless user devices of available network slices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method, the method comprising:
receiving data generated by a diagnostics application hosted by a wireless user device that characterizes user behavior;
correlating the user behavior to a wireless network slice that the user device is not authorized to use;
generating a slice notification that identifies the wireless network slice; and
delivering the slice notification to the wireless user device wherein the wireless user device receives and displays the slice notification.

2. The method of claim 1 further comprising:
determining service attributes for the wireless network slice based on the user behavior; and
generating the wireless network slice that comprises the service attributes.

3. The method of claim 2 wherein the service attributes comprise at least one of a Quality-of-Service (QOS), a latency, an uplink throughput, a downlink throughput, a bit rate, or a Guaranteed Bit Rate (GBR) requirement.

4. The method of claim 1 wherein the data generated by the diagnostics application hosted by the wireless user device comprises application usage, application type, uplink data volume, and downlink data volume.

5. The method of claim 4 wherein correlating the user behavior to the wireless network slice comprises categorizing the wireless user device based on the application usage, application type, uplink data volume, and downlink data volume and selecting the wireless network slice based on the categorization.

6. The method of claim 5 wherein the categorization associates a user type with a wireless network slice type.

7. The method of claim 1 wherein the slice notification comprises a link to purchase a subscription for the wireless network slice.

8. A wireless communication network, the wireless communication network comprising:
a network analytics service to:
receive data generated by a diagnostics application hosted by a wireless user device that characterizes user behavior;
correlate the user behavior to a wireless network slice that the user device is not authorized to use; and
a slice notification system to:
generate a slice notification that identifies the wireless network slice; and
deliver the slice notification to the wireless user device wherein the wireless user device receives and displays the slice notification.

9. The wireless communication network of claim 8 wherein the network analytics service is to:
determine service attributes for the wireless network slice based on the user behavior; and further comprising:
a network slice manager to:
generate the wireless network slice that comprises the service attributes.

10. The wireless communication network of claim 9 wherein the service attributes comprise at least one of a Quality-of-Service (QOS), a latency, an uplink throughput, a downlink throughput, a bit rate, or a Guaranteed Bit Rate (GBR) requirement.

11. The wireless communication network of claim 8 wherein the data generated by the diagnostics application hosted by the wireless user device comprises application usage, application type, uplink data volume, and downlink data volume.

12. The wireless communication network of claim 11 wherein the network analytics service is to categorize the wireless user device based on the application usage, application type, uplink data volume, and downlink data volume and select the wireless network slice based on the categorization.

13. The wireless communication network of claim 12 wherein the categorization associates a user type with a wireless network slice type.

14. The wireless communication network of claim 8 wherein the slice notification comprises a link to purchase a subscription for the wireless network slice.

15. One of more non-transitory computer readable storage media having program instructions stored thereon, wherein the program instruction, when executed by a computing system, direct the computing system to perform operations, the operations comprising:
receiving data generated by a diagnostics application hosted by a wireless user device that characterizes user behavior;
correlating the user behavior to a wireless network slice that the user device is not authorized to use;
generating a slice notification that identifies the wireless network slice; and
delivering the slice notification to the wireless user device wherein the wireless user device receives and displays the slice notification.

16. The computer readable storage media of claim 15, wherein the operation further comprise:
determining service attributes for the wireless network slice based on the user behavior; and
generating the wireless network slice that comprises the service attributes.

17. The computer readable storage media of claim 16 wherein the service attributes comprise at least one of a Quality-of-Service (QOS), a latency, an uplink throughput, a downlink throughput, a bit rate, or a Guaranteed Bit Rate (GBR) requirement.

18. The computer readable storage media of claim 15 wherein the data generated by the diagnostics application hosted by the wireless user device comprises application usage, application type, uplink data volume, and downlink data volume.

19. The computer readable storage media of claim 18 wherein correlating the user behavior to the wireless network slice comprises categorizing the wireless user device based on the application usage, application type, uplink data volume, and downlink data volume and selecting the wireless network slice based on the categorization.

20. The computer readable storage media of claim 19 wherein the categorization associates a user type with a wireless network slice type.
